(19) United States
(12) Patent Application Publication
(10) Pub. No.: US 2014/0031512 A1
(43) Pub. Date: Jan. 30, 2014

(54) POLYMER COMPOSITION, PROCESS FOR PREPARING AND ARTICLES OBTAINED FROM THE COMPOSITION

(71) Applicants: Cornelia Emilie Maria Bronsaer, Echt (NL); John Falke, Echt (NL)

(72) Inventors: Cornelia Emilie Maria Bronsaer, Echt (NL); John Falke, Echt (NL)

(73) Assignee: DSM IP ASSETS B.V., HEERLEN (NL)

(21) Appl. No.: 13/878,861

(22) PCT Filed: Oct. 20, 2011
(86) PCT No.: PCT/EP11/68358

§ 371 Date: Oct. 15, 2013

(30) Foreign Application Priority Data
Oct. 25, 2010 (EP) 10013929.4

(51) Int. Cl. C08G 69/14

(52) U.S. Cl. CPC C08G 69/14
USPC 528/323

(57) ABSTRACT

This invention relates to a polymer composition comprising monomeric units derived from caprolactam, wherein a) the caprolactam content is at most 0.3 wt % based on the total amount of polymer composition, and b) wherein [acid end groups]−[amine end groups]≧meq/kg, whereby [acid end groups] is the concentration of acid end groups in the polymer composition in meq/kg and [amine end groups] is the concentration of amine end groups in the polymer composition in meq/kg; c) and wherein the RSV is at least 2.8. This invention also relates to a process for producing this polymer composition as well as articles made thereof.

This invention relates to a polymer composition comprising monomeric units derived from caprolactam, process for preparing a polymer composition and articles obtained from the composition.

Polymer compositions comprising monomeric units derived from caprolactam are known from the prior art. However, upon melt-processing of the composition to prepare articles emission of caprolactam is observed. This phenomena results in deposits in the factory which have to be cleaned regularly, as well as environmental issues. It is thus desirable to have less caprolactam emission during melt-processing of the composition.

One solution to this problem as known in the prior art is to reduce the caprolactam content in the polymer. This is for example achieved by water extraction of the formed polymer. A disadvantage of this method is that the thus obtained polymer still exhibits caprolactam emission during melt-processing.

It is thus an object of the present invention to provide a polymer composition that shows less caprolactam emission during melt-processing of the composition.

Surprisingly, it has been found that a polymer composition comprising monomeric units derived from caprolactam, wherein
a) the caprolactam content is at most 0.3 wt % based on the total amount of polymer composition, and
b) wherein [acid end groups]−[amine end groups] is at least 0 meq/kg, whereby [acid end groups] is the concentration of acid end groups in the polymer composition in meq/kg and [amine end groups] is the concentration of amine end groups in the polymer composition in meq/kg, and
c) wherein the relative solution viscosity is at least 2.8,
shows less caprolactam emission during melt-processing. This has been exemplified by the examples below. Preferably [acid end groups]−[amine end groups] is at least 1 meq/kg, more preferably at least 2 meq/kg, at least 3 meq/kg, at least 4 meq/kg, at least 5 meq/kg. Even more preferred [acid end groups]−[amine end groups] is at least 6 meq/kg, at least 7 meq/kg, at least 8 meq/kg, at least 9 meq/kg. Most preferred [acid end groups]−[amine end groups] is at least 10 meq/kg. The end groups can be determined as described in the examples.

The polymer composition according to the invention shows less caprolactam emission, which results in less contamination, and allows for less stops during processing and is moreover beneficial for health and environmental reasons.

Preferably the total amount of [acid end groups]+[amine end groups] is at most 90 meq/kg, more preferably at most 85 meq/kg and even more preferred at most 80 meq/kg and most preferred at most 75 meq/kg, as this has the advantage that the polymer composition is very good processable into for example film applications.

### Polymer Composition and Caprolactam Content

The polymer composition according to the invention comprises preferably at least 80 wt % monomeric unites derived from caprolactam. Optionally, the polymer composition can be produced from a mixture of caprolactam monomer and other monomers such as the salt of hexamethylene diamine and adipic acid, hexamethylene diamine and terephtalic or isophtalic acid, or diaminobutane and adipic acid, terephtalic or isophtalic acid. These monomers may be present in an amount of preferably at most 20 wt % with respect to the total amount of monomer. A polymer composition also comprising units derived from other monomers is for example denoted as PA-6/66, PA-6/6T, PA6/6I, PA6/46 or PA6/4T according to the nomenclature as described in Nylon Plastics Handbook, M. I. Kohan, Hanser Publishers, 1995, page 5.

Preferably, the caprolactam content is measured after drying, thus prior to melt-processing. The caprolactam content is determined by high Pressure Liquid Chromatography (See for more information: J. Chromatogr. A 878 (2000) 45-55, J. Chromatogr. A 878 (2000) 45-55 and J. Chromatogr. A, 949 (2002) 307-326.). Preferably, the caprolactam content is at most 0.29, 0.28, 0.27, 0.26 or even lower, such as more preferably at most 0.25, 0.24, 0.23, 0.22, 0.21 or 0.20 or even more preferred at most 0.19, 0.18, 0.17, 0.16, 0.15 or even most preferred at most 0.13, 0.12 or 0.1, wherein the caprolactam content is given in wt % with respect to the total amount of polymer composition.

The polymer composition according to the invention has a relative solution viscosity of at least 2.8, preferably at least 2.9, more preferably at least 3.0, and even more preferred at least 3.1. The relative solution viscosity can be measured as described in the examples. Polymer compositions with higher viscosities are used for applications such as in films for packaging and tire cords or blow molded articles.

### Endcapper

The difference in [acid end groups] and [amine end groups] is preferably obtained by the presence of an endcapper, also known as chain stopper or chain terminator. An endcapper is a molecule that reacts with the amine end groups. Endcappers as such are known in the prior art and include monocarboxylic acids, dicarboxylic acids such as acetic acid, propionic acid, benzoic acid, terephtalic acid, isophtalic acid or adipic acid. Preferably, the amount of endcapper is at least 5 meq/kg polymer, more preferably at least 6 meq/kg, at least 7 meq/kg, at least 8 meq/kg, at least 9 meq/kg, at least 10 meq/kg and most preferred at least 15 meq/kg.

The endcapper can be added to caprolactam monomer upon polymerization, but can also be added to the melt, as well as during solid state post condensation.

Surprisingly, for a polymer composition with relative solution viscosity of at least 2.8, preferably at least 2.9, more preferably at least 3.0, addition of endcapper results in less caprolactam formation during melt-processing.

### Further Additives

The polymer according to the invention might optionally contain further additives such as lubricants, anti-blocking agents, nucleating agents, mold release agents. It might also comprise secondary or tertiary amines to improve adhesion to tie-layers, such as for example to tie-layers of MZA-grafted polyolefins, or to improve adhesion for coatings. The amine groups of these components are not taken into account for determining the concentration of amine end groups in the polymer composition in meq/kg, as these are not considered as reactive amine end groups in the polycondensation reaction of the polymer composition.

### Process for Obtaining a Polymer Composition

This invention also relates to a process for obtaining a polymer composition according to the invention. A known process for obtaining a polymer composition comprising monomeric units derived from caprolactam is the process of hydrolytic polymerization. This process includes the following steps:
1. heating a mixture of at least molten caprolactam and water to a polymerization temperature;
2. prepolymerizing this mixture to obtain a polymer of medium relative solution viscosity, while keeping the mixture in the molten phase;
3. depressurizing the polymer obtained at step 2 while keeping the polymer in the melt to further polymerize the polymer;
4. granulating the polymer obtained in step 3 to form particles below the melting temperature;
5. extracting the particles with hot water;
6. drying the particles obtained in step 5 to obtain a material with low water content.

It has now surprisingly been found that when the absolute pressure in step 3 is a reduced pressure, thus less than 1000 mbar and an endcapper is present in an amount of at least 5 meq/kg with respect to the total amount polymer composition, a polymer composition is obtained according to the invention. This polymer composition shows less caprolactam emission during melt-processing.

Preferably, the absolute pressure is at most 900 mbar, more preferably at most 800 mbar. The minimum pressure will be determined by the apparatus used, but will usually be at least 200 mbar. Most preferred is an absolute pressure between 300 and 700 mbar. Preferably, the amount of endcapper is at least 6 meq/kg polymer, at least 7 meq/kg, at least 8 meq/kg, at least 9 meq/kg, more preferably at least 10 meq/kg and most preferred at least 15 meq/kg.

Optionally, the process can be followed by solid state post condensation to increase the molecular weight of the polymer composition. Solid state post condensation is a technique known per se, and results in a polymer composition with higher relative solution viscosities. The endcapper can be added during any of the steps above, as well as during solid state post condensation.

In step 1 the polymerization temperature is usually a temperature above the melting temperature of the resulting polymer composition.

In step 2 a medium relative solution viscosity is usually in the range between 1.3 and 2.0.

In step 5, the temperature is usually between 95 to 120° C. Extraction is performed to remove caprolactam and oligomers. Preferably, extraction results in a caprolactam content of at most 0.29, 0.28, 0.27, 0.26 or even lower, such as more preferably at most 0.25, 0.24, 0.23, 0.22, 0.21 or 0.20 or even more preferred at most 0.19, 0.18, 0.17, 0.16, 0.15 or even most preferred at most 0.13, 0.12 or 0.1, wherein the caprolactam content is given in wt % with respect to the total amount of polymer composition. A lower caprolactam content is advantageous, as less caprolactam emission is observed during melt-processing.

In step 6 a low water content is usually between 100 to 1000 ppm, preferably less than 600 ppm.

The process can be a batch-process or continuous process. Preferably, the process is a continuous process, as this is a more stable process and has better capability and is cheaper than a batch process.

Articles made from Polymer Composition

The invention also relates to articles made from the polymer composition according to the invention. These articles include all extrusion applications, such as foil, film, mono- and multifilaments and fibres. During preparation of these articles, the polymer composition is melted during which less caprolactam emission is observed than with polymers composition according to the prior art.

The invention will now be elucidated by examples, without the wish to be limited thereto.

### EXAMPLES

### RSV

Relative solution viscosity (RSV) was measured in formic acid 90% at a temperature of 25° C. according to ISO307, with the exception that the concentration of the polyamide was 0.01 g/ml.

### End Groups.

The carboxyl end groups [COOH] were potentiometrically determined in tertbutyl phenol by means of a titration with tertbutyl ammonium hydroxide. The amino end groups [NH2] were potentiometrically determined in m-cresol by means of a titration with hydrochloric acid.

### Outgassing

To simulate melt-processing, outgassing experiments were performed at a temperature of 290° C. with granules using dynamic headspace chromatography to determine caprolactam that was evaporated from the melt at specific intervals (at t=0, 5, 10 and 15 minutes). Cumulative values of caprolactam amounts expressed in wt % with respect to the total polymer composition are shown in table 1.

TABLE 1
Outgassing experiments

| | | | | Caprolactam amount | | | |
|---|---|---|---|---|---|---|---|
| Example | polymer | RSV | [COOH]—[NH2] | t = 0; | t = 5 min | t = 10 min | t = 15 min |
| 1 | PA6 | 3.0 | 10 | 0.13 | 0.45 | 0.54 | 0.72 |
| Comp A | PA6 | 3.0 | −5 | 0.17 | 0.73 | 0.87 | 1.07 |
| Comp B | UBE1022B; | 3.0 | −4 | 0.05 | 0.58 | 0.74 | 0.88 |
| | PA6 | | | | | | |
| Comp C | UltramidB32; | 2.85 | 14 | 0.32 | 0.62 | 0.69 | 0.86 |
| | PA6 | | | | | | |

Table 1 clearly shows that the polymer according to the invention (Example 1) exhibits lowest outgassing of caprolactam. Comparative example A and B show that when [COOH]-[NH2] is too low, the outgassing is much higher, even though the caprolactam content at t=0 is very low in Comparative Example B. On the other hand, Comparative example C shows that even though [COOH]-[NH2] is high, the outgassing of caprolactam is still unfavorable.

1. Polymer composition comprising monomeric units derived from caprolactam, characterized in that
a) the caprolactam content is at most 0.3 wt % based on the total amount of polymer composition, and
b) wherein [acid end groups]−[amine end groups] is at least 0 meq/kg, whereby [acid end groups] is the concentration of acid end groups in the polymer composition in meq/kg and [amine end groups] is the concentration of amine end groups in the polymer composition in meq/kg;
c) and wherein the RSV is at least 2.8.

2. Polymer composition according to claim 1, characterized in that the caprolactam content is at most 0.2 wt % based on the total amount of polymer composition.

3. Polymer composition according to claim 1, characterized in that
[acid end groups]−[amine end groups] is at least 5 meq/kg,
whereby [acid end groups] is the concentration of acid end groups in the polymer composition in meq/kg and [amine end groups] is the concentration of amine end groups in the polylcaprolactam composition in meq/kg.

4. Polymer composition according to claim 1, characterized in that the composition comprises an endcapper in an amount of at least 5 meq/kg polymer composition.

5. Polymer composition according to claim 4, characterized in that the endcapper is chosen from the group of monocarboxylic acid and dicarboxylic acid.

6. Polymer composition according to claim 1, characterized in that the RSV is at least 3.0.

7. Polymer composition according to claim 1, characterized in that the total amount of [acid end groups]+[amine end groups] is at most 80 meq/kg.

8. Process for preparing a polymer composition according to claim 1, including the following steps:
1. heating a mixture of at least molten caprolactam and water to a polymerization temperature;
2. prepolymerizing this mixture to obtain a polymer of medium relative solution viscosity, while keeping the mixture in the molten phase;
3. depressurizing the polymer obtained at step 2 while keeping the polymer in the melt to further polymerize the polymer;
4. granulating the polymer obtained in step 3 to form particles below the melting temperature;
5. extracting the particles with hot water;
6. drying the particles obtained in step 5 to obtain a material with low water content,
characterized in that step 3 conducted at an absolute pressure below 1000 mbar and in which an endcapper is present in an amount of at least 5 meq/kg with respect to the total amount polymer composition.

9. Process according to claim 8 for preparing a polymer composition characterized in that the absolute pressure in step 3 is between 300 and 700 mbar.

10. Film, foil, filaments, fiber, or blow-molded object, obtained from a polymer composition according to claim 1.
